(19) United States
(12) Patent Application Publication
(10) Pub. No.: US 2006/0041860 A1
(43) Pub. Date: Feb. 23, 2006

(54) Interrupts in a graphical programming system

(75) Inventors: Philip G. Carmichael, Austin, TX (US); Andrew P. Dove, Austin, TX (US)

Correspondence Address: MEYERTONS, HOOD, KIVLIN, KOWERT & GOETZEL, P.C., P.O. BOX 398, AUSTIN, TX, 78767-0398, US

(73) Assignee: National Instruments Corporation

(21) Appl. No.: 10/978,803

(22) Filed: Nov. 1, 2004

Related U.S. Application Data
(60) Provisional application No. 60/602,215, filed on Aug. 17, 2004.

(51) Int. Cl. G06F 9/44

(52) U.S. Cl. 717/109

(57) ABSTRACT

System and method for using interrupts in a graphical programming system. A graphical program (GP) comprising a plurality of interconnected nodes which visually indicate functionality of the program is stored on a host computer, where the GP is executable to access a device. The GP and an interrupt service routine (ISR) may be created in response to user input, and if created on another computer system, deployed to the host computer. The GP includes program instructions, e.g., an ISR registration node, e.g., generated and/or included in response to user input, which are executable to register the ISR, and may also include an ISR node representing the ISR. The ISR is stored, and the GP executed, including registering the ISR with the host computer and executing the ISR in response to an interrupt from the device, including acknowledging/clearing the interrupt, and invoking a function, e.g., by invoking an interrupt service thread.

### PRIORITY DATA

This application claims benefit of priority of U.S. Provisional Application Ser. No. 60/602,215 titled “Interrupts In A Graphical Programming System”, filed Aug. 17, 2004, whose inventors were Philip G. Carmichael and Andrew P. Dove.

### FIELD OF THE INVENTION

The present invention relates to the field of graphical programming, and more particularly to a system and method for using interrupts in a graphical programming system.

### DESCRIPTION OF THE RELATED ART

Traditionally, high level text-based programming languages have been used by programmers in writing application programs. Many different high level text-based programming languages exist, including BASIC, C, C++, Java, FORTRAN, Pascal, COBOL, ADA, APL, etc. Programs written in these high level text-based languages are translated to the machine language level by translators known as compilers or interpreters. The high level text-based programming languages in this level, as well as the assembly language level, are referred to herein as text-based programming environments.

Increasingly, computers are required to be used and programmed by those who are not highly trained in computer programming techniques. When traditional text-based programming environments are used, the user's programming skills and ability to interact with the computer system often become a limiting factor in the achievement of optimal utilization of the computer system.

There are numerous subtle complexities which a user must master before he can efficiently program a computer system in a text-based environment. The task of programming a computer system to model or implement a process often is further complicated by the fact that a sequence of mathematical formulas, steps or other procedures customarily used to conceptually model a process often does not closely correspond to the traditional text-based programming techniques used to program a computer system to model such a process. In other words, the requirement that a user program in a text-based programming environment places a level of abstraction between the user's conceptualization of the solution and the implementation of a method that accomplishes this solution in a computer program. Thus, a user often must substantially master different skills in order to both conceptualize a problem or process and then to program a computer to implement a solution to the problem or process. Since a user often is not fully proficient in techniques for programming a computer system in a text-based environment to implement his solution, the efficiency with which the computer system can be utilized often is reduced.

To overcome the above shortcomings, various graphical programming environments now exist which allow a user to construct a graphical program or graphical diagram, also referred to as a block diagram. U.S. Pat. Nos. 4,901,221; 4,914,568; 5,291,587; 5,301,301; and 5,301,336; among others, to Kodosky et al disclose a graphical programming environment which enables a user to easily and intuitively create a graphical program. Graphical programming environments such as that disclosed in Kodosky et al can be considered a higher and more intuitive way in which to interact with a computer. A graphically based programming environment can be represented at a level above text-based high level programming languages such as C, Basic, Java, etc.

A user may assemble a graphical program by selecting various icons or nodes which represent desired functionality, and then connecting the nodes together to create the program. The nodes or icons may be connected by lines representing data flow between the nodes, control flow, or execution flow. Thus the block diagram may include a plurality of interconnected icons such that the diagram created graphically displays a procedure or method for accomplishing a certain result, such as manipulating one or more input variables and/or producing one or more output variables. In response to the user constructing a diagram or graphical program using the block diagram editor, data structures and/or program instructions may be automatically constructed which characterize an execution procedure that corresponds to the displayed procedure. The graphical program may be compiled or interpreted by a computer.

A graphical program may have a graphical user interface. For example, in creating a graphical program, a user may create a front panel or user interface panel. The front panel may include various graphical user interface elements or front panel objects, such as user interface controls and/or indicators, that represent or display the respective input and output that will be used by the graphical program, and may include other icons which represent devices being controlled.

Thus, graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, modeling, simulation, image processing/machine vision applications, motion control, and embedded applications, among others.

Many programs, e.g., driver software, require, or may benefit from, the use of interrupts, where an interrupt refers to a signal that informs a program that an event has occurred. Generally, when a program receives an interrupt signal, it responds by performing a specified function or action, typically by temporarily suspending its normal processing to service the interrupt. Interrupts (interrupt signals) may originate from a variety of sources. For example, hardware interrupts include keystroke interrupt signals from keyboards, and interrupts from other devices, such as printers, indicating that some event has occurred. Software interrupts are interrupt signals initiated by programs, and are also referred to as traps or exceptions.

Interrupts are typically written in C and assembly, and are generally registered with the operating system, where the details of how this happens vary depending on the OS/platform. However, implementation and use of interrupts is not generally supported in prior art graphical programming systems.

### SUMMARY OF THE INVENTION

One embodiment of the present invention comprises a system and method for creating, registering, and using interrupts in a graphical programming system. The following describes a method for creating a graphical program utilizing interrupts, according to one embodiment.

First, a graphical program may be stored, e.g., on host computer system, on a different computer system, or on another host device, each of which may be referred to as a host computer, where the graphical program is executable to access a device, such as, for example, instrumentation and control devices, including but not limited to: a GPIB instrument and associated GPIB interface card, a data acquisition board and associated signal conditioning circuitry, a VXI instrument, a PXI instrument, a video device or camera and associated image acquisition (or machine vision) card, a motion control device and associated motion control interface card, and/or one or more computer based instrument cards, a fieldbus device and associated fieldbus interface card, a PLC (Programmable Logic Controller), a serial instrument and associated serial interface card, or a distributed data acquisition system, such as the Fieldpoint system available from National Instruments, among other types of devices.

The graphical program may be created or assembled by the user arranging on a display a plurality of nodes or icons and then interconnecting the nodes to create the graphical program, e.g., in a graphical programming development environment, such as LabVIEW, provided by National Instruments Corporation. In response to the user assembling the graphical program, data structures may be created and stored which represent the graphical program. The nodes may be interconnected in one or more of a data flow, control flow, or execution flow format. The graphical program may thus comprise a plurality of interconnected nodes or icons which visually indicates the functionality of the program. The graphical program also preferably includes a plurality of data elements, e.g., data structures, such as arrays, clusters, objects (e.g., instantiated from classes), and so forth.

The graphical program may comprise a block diagram and may also include a user interface portion or front panel portion. Where the graphical program includes a user interface portion, the user may optionally assemble the user interface on the display. As one example, the user may use the LabVIEW graphical programming development environment to create the graphical program. The graphical program may implement a measurement function or any other type of function that is desired to be performed by the instrument.

An interrupt service routine (ISR) may be stored, e.g., on the host computer. The ISR may be created in response to user input. For example, in one embodiment, creating the graphical program may comprise including an ISR node in the graphical program in response to user input, where the ISR node represents the interrupt service routine (ISR). The ISR node may include text-based program code, or may be implemented entirely in a graphical programming language, such as the “G” graphical programming language of the LabVIEW environment.

In one embodiment, creating the graphical program may include displaying a configuration graphical user interface (GUI) in response to user input, receiving user input to the configuration GUI specifying the ISR, and programmatically generating the program instructions implementing the ISR in response to the specifying. In other words, the user may create the ISR manually, or via a development tool that may be operable to programmatically generate the ISR based on user input.

For example, the user may create the ISR as a callable node, referred to as a subVI in the LabVIEW system, and may include or associate program instructions, e.g., in C or some other text-based programming language, with the node. Alternatively, the user may write a graphical program implementing the ISR, referred to as a VI in the LabVIEW system, and may associate or represent the ISR with the ISR node, e.g., as a subVI.

In embodiments where the graphical program is created on a different computer system than the host computer, the method may include deploying the graphical program and the ISR to the host computer.

The graphical program may be executed, e.g., to perform the functionality specified by the user. For example, the graphical program may be executed in response to user input invoking execution of the program, e.g., from an integrated development environment (IDE), such as LabVIEW, executing on the host computer. In another embodiment, the graphical program may be deployed to another hardware device, e.g., an embedded device, and execution initiated by user input to the embedded device, by user input received to a front panel on a host device, e.g., computer system, or automatically, e.g., upon deployment to the embedded device.

Executing the graphical program may include registering the ISR. The registration may be specified and performed in a variety of different ways. For example, the graphical program may include program instructions, e.g., graphical or text-based, that are executable to perform the registration of the ISR. Thus, in one embodiment, creating the graphical program may comprise including program instructions in the graphical program which are executable to register the ISR. For example, including program instructions in the graphical program may comprise including an ISR registration node in the graphical program in response to user input, e.g., by the user “dragging and dropping” the ISR registration node into the graphical program, i.e., onto a block diagram of the graphical program. The ISR registration node may then be executable to perform the registration, i.e., as part of the execution of the graphical program. In an embodiment where the graphical program is converted to a text-based form for execution, the method may include generating text-based program instructions based on the ISR registration node, where the text-based program instructions are executable to perform the registration.

In other embodiments, including the program instructions in the graphical program for registering the ISR may include displaying a configuration graphical user interface (GUI) in response to user input, receiving user input to the configuration GUI specifying registration of the ISR, and generating the program instructions in the graphical program in response to the specifying. In other words, the user may specify the registration via a GUI, such as a wizard or configuration program, and corresponding program instructions (either text-based or graphical source code) may be automatically generated and included in the graphical program. Note that in various embodiments, the generated code may be visible to the user (e.g., the ISR registration node may be programmatically inserted into the graphical program), or may not be visible to the user (e.g., the program instructions may “underlie” the graphical program nodes). In one embodiment, registering the ISR may include loading a function pointer for the ISR into a register of the host computer.

Finally, the (registered) ISR may execute in response to an interrupt from the device. In other words, during execution of the graphical program, the device may generate an interrupt. The ISR may then receive or intercept the interrupt, and execute in response. For example, in an embodiment where the ISR was registered by loading a function pointer for the ISR into a register of the host computer, the loaded function pointer may be used to invoke the ISR to “handle” the interrupt.

In some embodiments, executing the ISR in response to an interrupt from the device may include executing the ISR to perform one or more of: acknowledging the interrupt, clearing the interrupt, and invoking a function. For example, in one embodiment, invoking a function may include invoking an interrupt service thread, e.g., where the interrupt service thread is specifically for processing functions related to interrupts. It should be noted that the ISR may perform any type of function as desired, including doing nothing at all, i.e., ignoring the interrupt. For example, in some embodiments, the ISR may include any functionality for handling the request itself, or may invoke other functions, as noted above.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system operable to execute a graphical program according to an embodiment of the present invention;

FIG. 1B illustrates a network system comprising two or more computer systems that may implement an embodiment of the present invention;

FIG. 2A illustrates an instrumentation control system according to one embodiment of the invention;

FIG. 2B illustrates an industrial automation system according to one embodiment of the invention;

FIG. 3A is a high level block diagram of an exemplary system which may execute or utilize graphical programs;

FIG. 3B illustrates an exemplary system which may perform control and/or simulation functions utilizing graphical programs;

FIG. 4 is an exemplary block diagram of the computer systems of FIGS. 1A, 1B, 2A and 2B and 3B;

FIG. 5 is a flowchart diagram illustrating one embodiment of a method for implementing and using interrupts in a graphical program;

FIG. 6 illustrates an example ISR registration API, according to one embodiment;

FIGS. 7 and 8 illustrate example use cases for interrupt handling with an ISR, according to one embodiment;

FIG. 9 illustrates traditional vs. ISR paths for interrupt handling, according to one embodiment; and

FIG. 10-12 illustrate one embodiment of a graphical user interface for specifying and configuring an interrupt service routine (ISR), according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Incorporation by Reference

The following references are hereby incorporated by reference in their entirety as though fully and completely set forth herein:

U.S. Provisional Application Ser. No. 60/602,215 titled “Interrupts In A Graphical Programming System”, filed August 17.

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. Patent Application Publication No. 20010020291 (Ser. No. 09/745,023) titled “System and Method for Programmatically Generating a Graphical Program in Response to Program Information,” filed Dec. 20, 2000, currently pending.

Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as signals such as electrical, electromagnetic, or digital signals, conveyed via a communication medium such as a bus, network and/or a wireless link.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium, carrier medium, and/or programmable hardware element; encompasses various types of mediums that can either store program instructions/data structures or can be configured with a hardware configuration program. For example, a medium that is “configured to perform a function or implement a software object” may be 1) a memory medium or carrier medium that stores program instructions, such that the program instructions are executable by a processor to perform the function or implement the software object; 2) a medium carrying signals that are involved with performing the function or implementing the software object; and/or 3) a programmable hardware element configured with a hardware configuration program to perform the function or implement the software object.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, wherein the plurality of interconnected nodes or icons visually indicate functionality of the program.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW, DasyLab, DiaDem and Matrixx/SystemBuild from National Instruments, Simulink from the MathWorks, VEE from Agilent, WiT from Coreco, Vision Program Manager from PPT Vision, SoftWIRE from Measurement Computing, Sanscript from Northwoods Software, Khoros from Khoral Research, SnapMaster from HEM Data, Vis Sim from Visual Solutions, ObjectBench by SES (Scientific and Engineering Software), and VisiDAQ from Advantech, among others.

The term “graphical program” includes models or block diagrams created in graphical modeling environments, wherein the model or block diagram comprises interconnected nodes or icons that visually indicate operation of the model or block diagram; exemplary graphical modeling environments include Simulink, SystemBuild, Vis Sim, Hypersignal Block Diagram, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected nodes are often referred to as the block diagram portion of the graphical program.

Node—In the context of a graphical program, an element that may be included in a graphical program. A node may have an associated icon that represents the node in the graphical program, as well as underlying code or data that implements functionality of the node. Exemplary nodes include function nodes, terminal nodes, structure nodes, etc. Nodes may be connected together in a graphical program by connection icons or wires.

Data Flow Graphical Program (or Data Flow Diagram)—A graphical program or diagram comprising a plurality of interconnected nodes, wherein the connections between the nodes indicate that data produced by one node is used by another node.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators

Input Control—a graphical user interface element for providing user input to a program. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Interrupt—a signal that informs a program that an event has occurred. An interrupt may originate from hardware (a hardware interrupt), or from a program (a software interrupt, also known as an exception or trap).

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

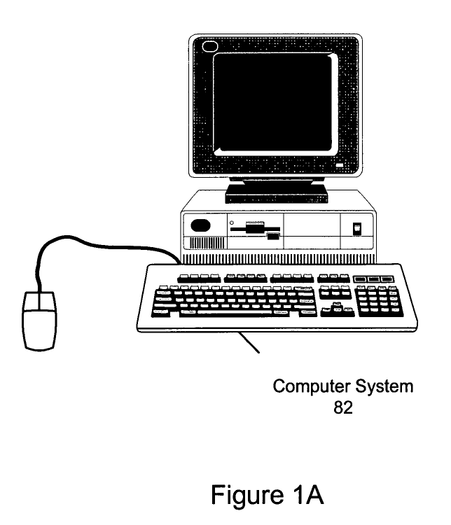

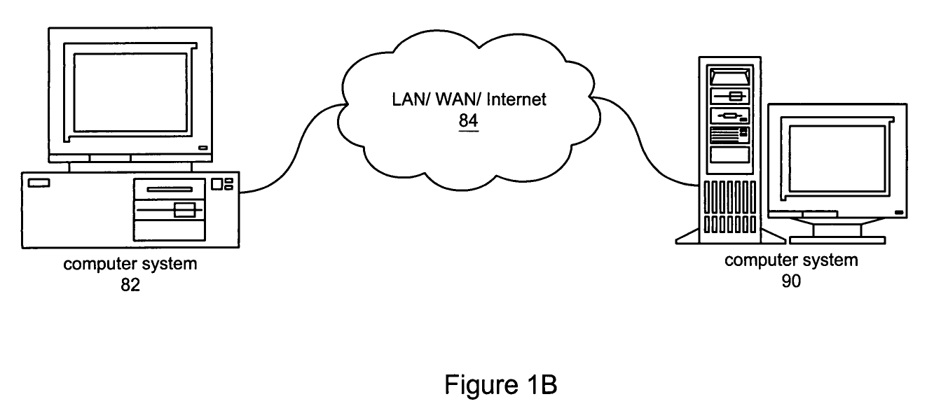

FIG. 1A—Computer System

FIG. 1A illustrates a computer system 82 operable to implement various embodiments of the present invention. One embodiment of a method for implementing interrupts in a graphical programming system is described below.

As shown in FIG. 1A, the computer system 82 may include a display device operable to display the graphical program as the graphical program is created and/or executed. The display device may also be operable to display a graphical user interface or front panel of the graphical program during execution of the graphical program. The graphical user interface may comprise any type of graphical user interface, e.g., depending on the computing platform.

The computer system 82 may include a memory medium(s) on which one or more computer programs or software components according to one embodiment of the present invention may be stored. For example, the memory medium may store one or more graphical programs which are executable to perform the methods described herein. Also, the memory medium may store a graphical programming development environment application used to create and/or execute such graphical programs. The memory medium may also store operating system software, as well as other software for operation of the computer system. Various embodiments further include receiving or storing instructions and/or data implemented in accordance with the foregoing description upon a carrier medium.

FIG. 1B—Computer Network

FIG. 1B illustrates a system including a first computer system 82 that is coupled to a second computer system 90. The computer system 82 may be connected through a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a graphical program in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the graphical program may be displayed on a display device of the computer system 82, and the block diagram may execute on a device 190 connected to the computer system 82. The device 190 may include a programmable hardware element and/or may include a processor and memory medium which may execute a real time operating system. In one embodiment, the graphical program may be downloaded and executed on the device 190. For example, an application development environment with which the graphical program is associated may provide support for downloading a graphical program for execution on the device in a real time system.

Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others.

However, it is noted that the present invention can be used for a plethora of applications and is not limited to the above applications. In other words, applications discussed in the present description are exemplary only, and the present invention may be used in any of various types of systems. Thus, the system and method of the present invention is operable to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

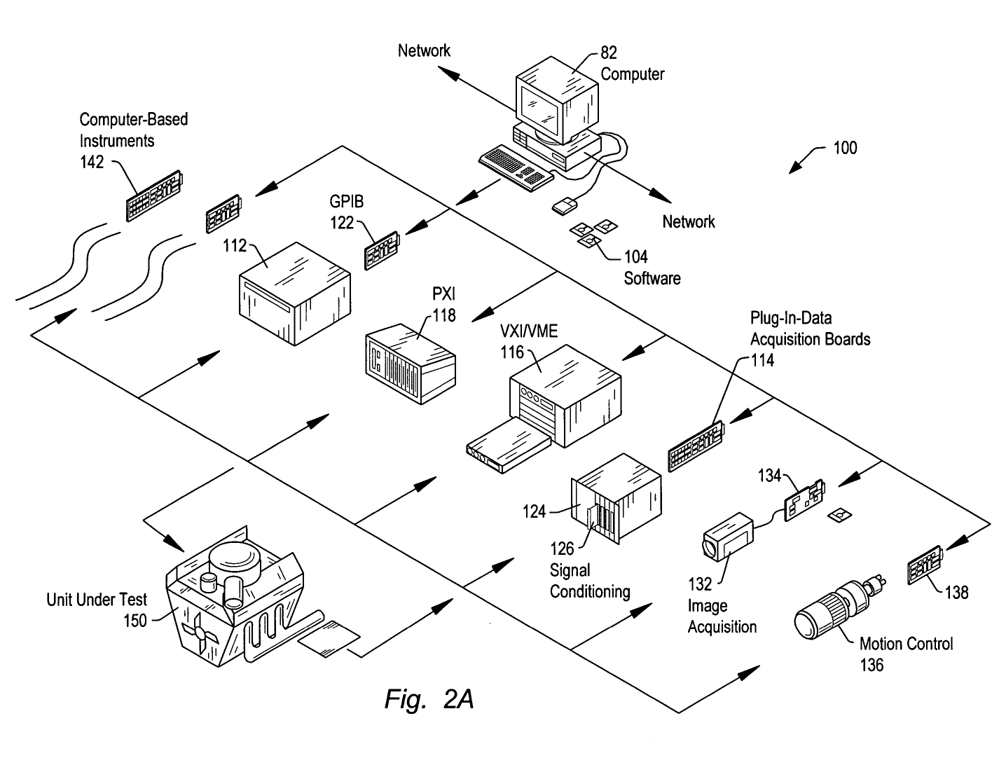

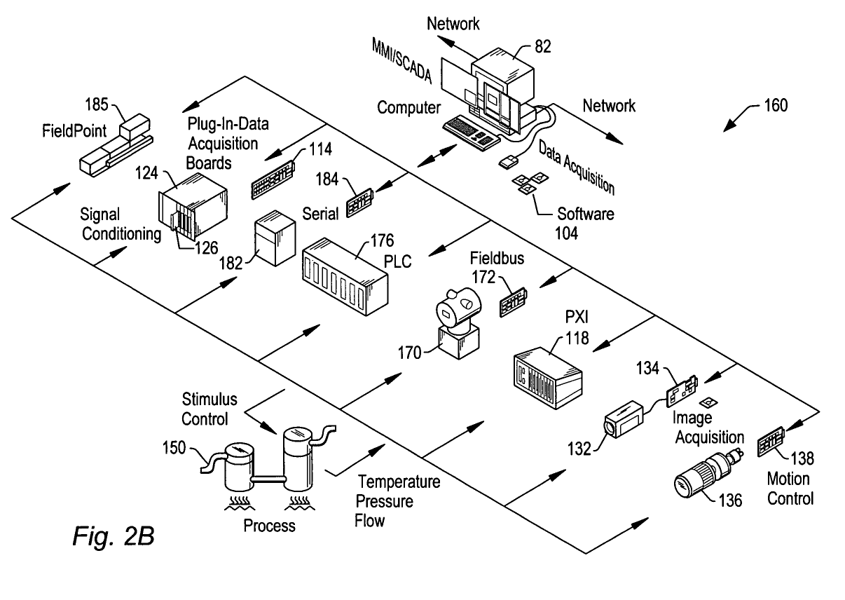

FIG. 2A illustrates an exemplary instrumentation control system 100 which may implement embodiments of the invention. The system 100 comprises a host computer 82 which connects to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 and associated signal conditioning circuitry 124, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to a unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which connects to one or more devices or instruments. The computer 82 may comprise a CPU, a display screen, memory, and one or more input devices such as a mouse or keyboard as shown. The computer 82 may operate with the one or more devices to a process or device 150 to perform an automation function, such as MMI (Man Machine Interface), SCADA (Supervisory Control and Data Acquisition), portable or distributed data acquisition, process control, advanced analysis, or other control, among others.

The one or more devices may include a data acquisition board 114 and associated signal conditioning circuitry 124, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

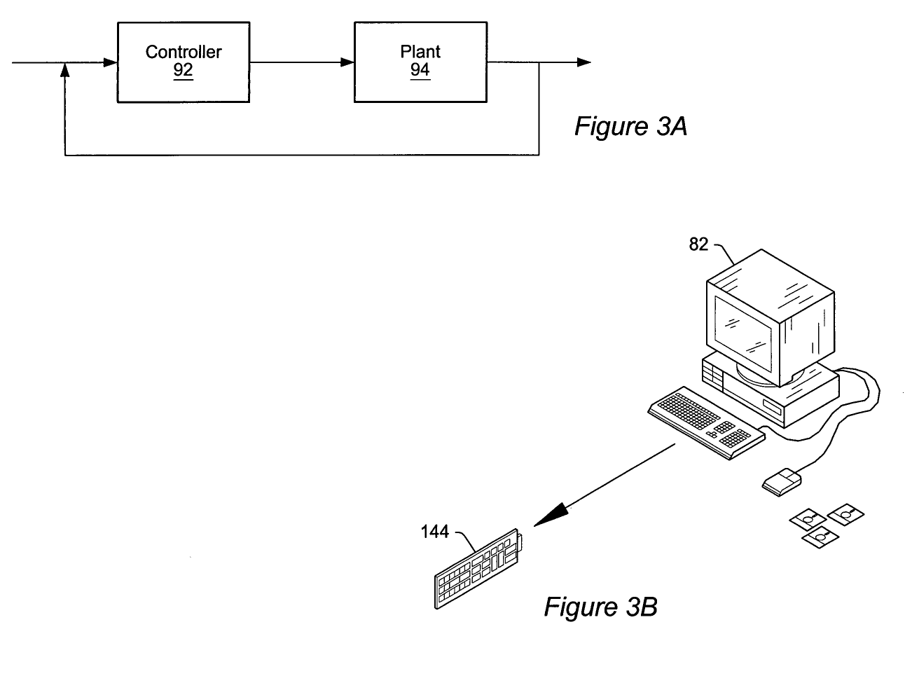

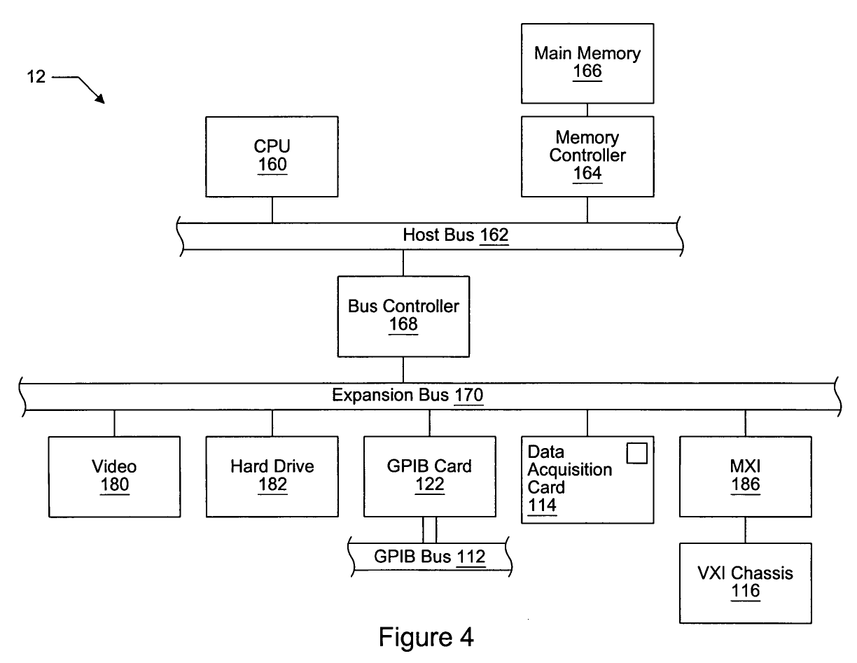

FIG. 3A is a high level block diagram of an exemplary system which may execute or utilize graphical programs. FIG. 3A illustrates a general high-level block diagram of a generic control and/or simulation system which comprises a controller 92 and a plant 94. The controller 92 represents a control system/algorithm the user may be trying to develop. The plant 94 represents the system the user may be trying to control. For example, if the user is designing an ECU for a car, the controller 92 is the ECU and the plant 94 is the car's engine (and possibly other components such as transmission, brakes, and so on.) As shown, a user may create a graphical program that specifies or implements the functionality of one or both of the controller 92 and the plant 94. For example, a control engineer may use a modeling and simulation tool to create a model (graphical program) of the plant 94 and/or to create the algorithm (graphical program) for the controller 92.

FIG. 3B illustrates an exemplary system which may perform control and/or simulation functions. As shown, the controller 92 may be implemented by a computer system 82 or other device (e.g., including a processor and memory medium and/or including a programmable hardware element) that executes or implements a graphical program. In a similar manner, the plant 94 may be implemented by a computer system or other device 144 (e.g., including a processor and memory medium and/or including a programmable hardware element) that executes or implements a graphical program, or may be implemented in or as a real physical system, e.g., a car engine.

In one embodiment of the invention, one or more graphical programs may be created which are used in performing rapid control prototyping. Rapid Control Prototyping (RCP) generally refers to the process by which a user develops a control algorithm and quickly executes that algorithm on a target controller connected to a real system. The user may develop the control algorithm using a graphical program, and the graphical program may execute on the controller 92, e.g., on a computer system or other device. The computer system 82 may be a platform that supports real time execution, e.g., a device including a processor that executes a real time operating system (RTOS), or a device including a programmable hardware element.

In one embodiment of the invention, one or more graphical programs may be created which are used in performing Hardware in the Loop (HIL) simulation. Hardware in the Loop (HIL) refers to the execution of the plant model 94 in real time to test operation of a real controller 92. For example, once the controller 92 has been designed, it may be expensive and complicated to actually test the controller 92 thoroughly in a real plant, e.g., a real car. Thus, the plant model (implemented by a graphical program) is executed in real time to make the real controller 92 “believe” or operate as if it is connected to a real plant, e.g., a real engine.

In the embodiments of FIGS. 2A, 2B, and 3B above, one or more of the various devices may couple to each other over a network, such as the Internet. In one embodiment, the user operates to select a target device from a plurality of possible target devices for programming or configuration using a graphical program. Thus the user may create a graphical program on a computer and use (execute) the graphical program on that computer or deploy the graphical program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

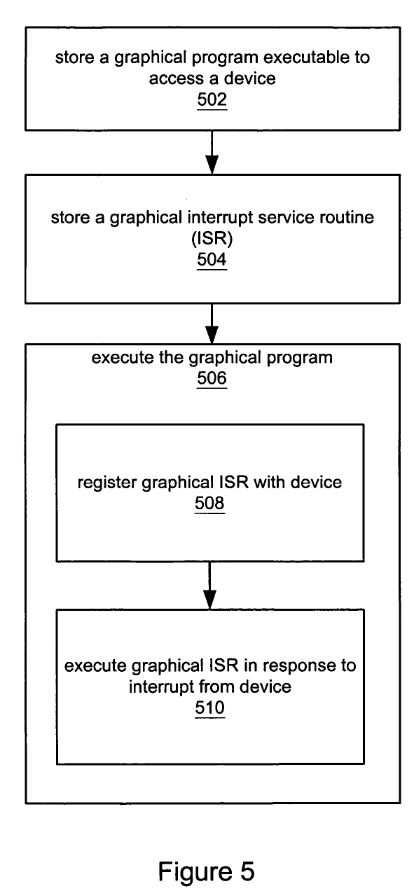

FIG. 4—Computer System Block Diagram

FIG. 4 is a block diagram representing one embodiment of the computer system 82 and/or 90 illustrated in FIGS. 1A and 1B, or computer system 82 shown in FIG. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store the graphical program operable to implement and utilize interrupts. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170.

As shown, a device 190 may also be connected to the computer. The device 190 may include a processor and memory which may execute a real time operating system. The device 190 may also or instead comprise a programmable hardware element. The computer system may be operable to deploy a graphical program to the device 190 for execution of the graphical program on the device 190. The deployed graphical program may take the form of graphical program instructions or data structures that directly represents the graphical program. Alternatively, the deployed graphical program may take the form of text code (e.g., C code) generated from the graphical program. As another example, the deployed graphical program may take the form of compiled code generated from either the graphical program or from text code that in turn was generated from the graphical program.

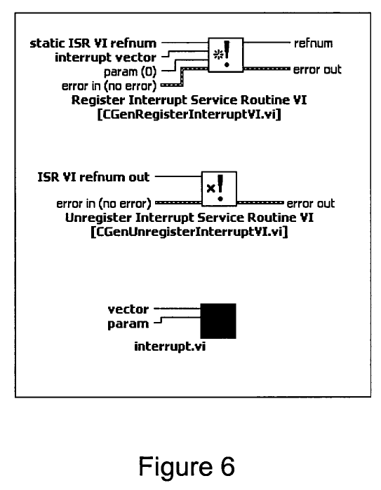

FIG. 5—Method for Implementing and Using Interrupts in a Graphical Programming System

FIG. 5 illustrates a method for creating a graphical program utilizing interrupts, according to one embodiment. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, as FIG. 5 shows, in 502 a graphical program may be stored, e.g., on host computer system 82, on a different computer system, or on another host device, each of which may be referred to as a host computer, where the graphical program is executable to access a device, such as, for example, any of the devices describe above with reference to FIGS. 2A-3B, among others.

The graphical program may be created or assembled by the user arranging on a display a plurality of nodes or icons and then interconnecting the nodes to create the graphical program, e.g., in a graphical programming development environment, such as LabVIEW, provided by National Instruments Corporation. Further details regarding creation of a graphical program are provided below. In response to the user assembling the graphical program, data structures may be created and stored which represent the graphical program. The nodes may be interconnected in one or more of a data flow, control flow, or execution flow format. The graphical program may thus comprise a plurality of interconnected nodes or icons which visually indicates the functionality of the program. The graphical program also preferably includes a plurality of data elements, e.g., data structures, such as arrays, clusters, objects (e.g., instantiated from classes), and so forth.

As noted above, the graphical program may comprise a block diagram and may also include a user interface portion or front panel portion. Where the graphical program includes a user interface portion, the user may optionally assemble the user interface on the display. As one example, the user may use the LabVIEW graphical programming development environment to create the graphical program.

In an alternate embodiment, the graphical program may be created in 502 by the user creating or specifying a prototype, followed by automatic or programmatic creation of the graphical program from the prototype. This functionality is described in U.S. patent application Ser. No. 09/587,682 titled “System and Method for Automatically Generating a Graphical Program to Perform an Image Processing Algorithm”, which is hereby incorporated by reference in its entirety as though fully and completely set forth herein. The graphical program may be created in other manners, either by the user or programmatically, as desired. The graphical program may implement a measurement function or any other type of function that is desired to be performed by the instrument.

In 504, an interrupt service routine (ISR) may be stored, e.g., on the host computer of 502. The ISR may be created in response to user input. For example, in one embodiment, creating the graphical program may comprise including an ISR node in the graphical program in response to user input, where the ISR node represents the interrupt service routine (ISR). The ISR node may include text-based program code, or may be implemented entirely in a graphical programming language, such as the “G” graphical programming language of the LabVIEW environment.

In one embodiment, creating the graphical program may include displaying a configuration graphical user interface (GUI) in response to user input, receiving user input to the configuration GUI specifying the ISR, and programmatically generating the program instructions implementing the ISR in response to the specifying. In other words, the user may create the ISR manually, or via a development tool that may be operable to programmatically generate the ISR based on user input.

For example, the user may create the ISR as a callable node, referred to as a subVI in the LabVIEW system, and may include or associate program instructions, say, in C or some other text-based programming language, with the node. Alternatively, the user may write a graphical program implementing the ISR, referred to as a VI in the LabVIEW system, and may associate or represent the ISR with the ISR node, e.g., as a subVI.

In embodiments where the graphical program is created on a different computer system than the host computer 82, the method may include deploying the graphical program and the ISR to the host computer.

In 506, the graphical program may be executed, e.g., to perform the functionality specified by the user. For example, the graphical program may be executed in response to user input invoking execution of the program, e.g., from an integrated development environment (IDE), such as LabVIEW, executing on the host computer. In another embodiment, the graphical program may be deployed to another hardware device, e.g., an embedded device, and execution initiated by user input to the embedded device, by user input received to a front panel on a host device, e.g., computer system 82, or automatically, e.g., upon deployment to the embedded device.

As FIG. 5 shows, executing the graphical program may include registering the ISR, as indicated in 508. The registration may be specified and performed in a variety of different ways. For example, the graphical program may include program instructions, e.g., graphical or text-based, that are executable to perform the registration of the ISR.

In one embodiment, creating the graphical program may comprise including program instructions in the graphical program which are executable to register the ISR. For example, including program instructions in the graphical program may comprise including an ISR registration node in the graphical program in response to user input, e.g., by the user “dragging and dropping” the ISR registration node into the graphical program, i.e., onto a block diagram of the graphical program. The ISR registration node may then be executable to perform the registration, i.e., as part of the execution of the graphical program. In an embodiment where the graphical program is converted to a text-based form for execution, the method may include generating text-based program instructions based on the ISR registration node, where the text-based program instructions are executable to perform the registration.

In other embodiments, including the program instructions in the graphical program for registering the ISR may include displaying a configuration graphical user interface (GUI) in response to user input, receiving user input to the configuration GUI specifying registration of the ISR, and generating the program instructions in the graphical program in response to the specifying. In other words, the user may specify the registration via a GUI, such as a wizard or configuration program, and corresponding program instructions (either text-based or graphical source code) may be automatically generated and included in the graphical program. Note that in various embodiments, the generated code may be visible to the user (e.g., the ISR registration node may be programmatically inserted into the graphical program), or may not be visible to the user (e.g., the program instructions may “underlie” the graphical program nodes).

In one embodiment, registering the ISR may include loading a function pointer for the ISR into a register of the host computer.

Finally, as FIG. 5 shows, in 510, the (registered) ISR may execute in response to an interrupt from the device. In other/words, during execution of the graphical program, the device may generate an interrupt. The ISR may then receive or intercept the interrupt, and execute in response. For example, in an embodiment where the ISR was registered by loading a function pointer for the ISR into a register of the host computer, the loaded function pointer may be used to invoke the ISR to “handle” the interrupt.

In some embodiments, executing the ISR in response to an interrupt from the device may include executing the ISR to perform one or more of: acknowledging the interrupt, clearing the interrupt, and invoking a function. For example, in one embodiment, invoking a function may include invoking an interrupt service thread (IST), e.g., where the interrupt service thread is specifically for processing functions related to interrupts. It should be noted that the ISR may perform any type of function as desired, including doing nothing at all, i.e., ignoring the interrupt. For example, in some embodiments, the ISR may include any functionality for handling the request itself, or may invoke other functions, as noted above.

Creating the Graphical Program

The following describes one embodiment of a method for creating a graphical program operable to receive and respond to user interface events. It is noted that method elements in the following flowcharts may occur concurrently or in different orders than that shown.

A graphical user interface or front panel for the graphical program may be created, e.g., in response to user input. The graphical user interface may be created in any of various ways, e.g., depending on the graphical programming development environment used. A block diagram for the graphical program may be created. The block diagram may be created in or using any graphical programming development environment, such as LabVIEW, Simulink, VEE, or another graphical programming development environment. The block diagram may be created in response to direct user input, e.g., the user may create the block diagram by placing or “dragging and dropping” icons or nodes on the display and interconnecting the nodes in a desired fashion. Alternatively, the block diagram may be programmatically created from a program specification. The plurality of nodes in the block diagram may be interconnected to visually indicate functionality of the graphical program. The block diagram may have one or more of data flow, control flow, and/or execution flow representations.

It is noted that the graphical user interface and the block diagram may be created separately or together, in various orders, or in an interleaved manner. In one embodiment, the user interface elements in the graphical user interface or front panel may be specified or created, and terminals corresponding to the user interface elements may appear in the block diagram in response. For example, when the user places user interface elements in the graphical user interface or front panel, corresponding terminals may appear in the block diagram as nodes that may be connected to other nodes in the block diagram, e.g., to provide input to and/or display output from other nodes in the block diagram. In another embodiment, the user interface elements may be created in response to the block diagram. For example, the user may create the block diagram, wherein the block diagram includes terminal icons or nodes that indicate respective user interface elements. The graphical user interface or front panel may then be automatically (or manually) created based on the terminal icons or nodes in the block diagram. As another example, the graphical user interface elements may be comprised in the diagram.

The graphical program may then be executed. The graphical program may be executed on any kind of computer system(s) or reconfigurable hardware, as described above. In some embodiments, during execution of the graphical program, the graphical user interface is displayed on a display of a first computer system and the block diagram executes on a second computer system. As noted above, the graphical program may be operable to perform any type of functionality specified, including, for example, one or more of: an industrial automation function, a process control function, and/or a test and measurement function, among others.

Code Generation

In a preferred embodiment, the graphical program may be used to generate a text-based program, which may then be compiled and executed. For example, in one embodiment, a C program may be generated based on the graphical program, e.g., for deployment onto an embedded device. Thus, after the interrupt handler has been implemented in the graphical programming language, a C generator may convert the graphical source code (e.g., interconnected nodes) to C code, although other text-based languages may also be used as desired. Said another way, the method may generate program code/objects based on the analysis of 504, where the program code/objects may be executable to implement the interrupt functionality described above.

In some embodiments where code is generated based on the ISR VI, there may be constraints on the code generation process. For example, in one embodiment, the generated code may be constrained to be serial with debugging disabled.

Example Implementation

The following describes a preferred embodiment of an implementation of the method of FIG. 5. It should be noted that while the implementation described is in terms of LabVIEW, this is not intended to limit the implementation to any particular functionality, form, or appearance. Similarly, the methods and techniques disclosed herein may be implemented for use with any operating systems (OSs) desired, including, for example, Windows, MacOS, Linux, Unix, eCos, and VxWorks, among others. Also, while the implementation disclosed below is directed at embedded applications, the techniques described herein may be used for any of various types of execution platforms, including desktop machines, workstations, and portable computing devices, among others.

In one embodiment, a user may write an ISR as a VI, e.g., as a LabVIEW graphical program. For example, in one embodiment, a development environment, e.g., an embedded project environment or GUI, may allow a user to create a new “Interrupt Service Routine VI”. The VI may have a strict connector pane (CP) that passes in an interrupt vector and a registered parameter, where, in the LabVIEW system, a connector pane specifies connectivity between a subVI and front panel elements, e.g., indicators and controls on the GUI for the VI, and may also specify communication between the subVI and its calling parent VI. If a VI is added as an ISR VI, e.g., via a “New . . . ” dialog or equivalent, then it may be automatically configured to be an interrupt VI. However, if the user wishes to adapt an existing VI to be an ISR, they may simply configure an existing VI, e.g., by selecting a menu item such as “Configure Interrupt VIs”, or equivalent.

In one embodiment, an ISR VI may have the syntax constraints of a reentrant-subroutine type without automatic error handling and with additional diagram syntax constraints. Front panels may not be runtime viewable and therefore may not be able to respond to user input via controls. Diagrams may not be debuggable. As noted above, in some embodiments, an inline C node may be supported in an ISR VI.

Because of ISR VI syntax restrictions, in some embodiments, a per-VI syntax checking capability may be provided, e.g., in the form of subroutine/reentrant checking, and may be flexible enough to accommodate per target differences. For example, in embedded applications, a special syntax case may specify that no memory allocations are allowed. In some embodiments, this type of syntax checking may occur at project build time, while in other embodiments, the syntax checking may be performed at edit time.

One common use case for ISR VIs is to write the ISR in LabVIEW specifically to acknowledge the interrupt, and then trigger an occurrence, where an occurrence refers to a function or functionality invoked by the ISR in response to the interrupt. A normal VI may then wait on the occurrence and do the appropriate hardware interaction. In this way, the common interrupt service routine/interrupt service thread method of handling interrupts may be maintained.

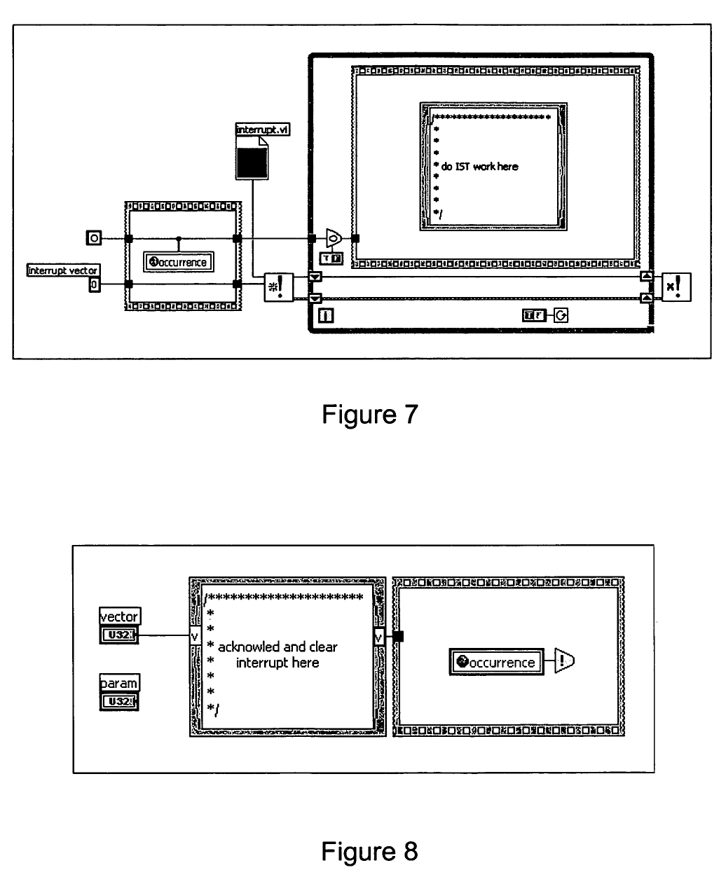

FIG. 6—ISR Registration

ISRs are traditionally registered and unregistered by device drivers. As the drivers are loaded and unloaded, they install and uninstall the ISR routine with a specific OS application program interface (API). A LabVIEW based API may provided to “install” into the OS. FIG. 6 illustrates an example API for registering the ISR, according to one embodiment. Note that this API is itself graphical, comprising graphical program nodes that may be included in a graphical program, e.g., either manually or programmatically.

As shown, FIG. 6 illustrates exemplary nodes for registering the ISR (top node), for unregistering the ISR (middle node), and the ISR itself (bottom node). It should be noted that this API is meant to be exemplary only, and is not intended to limit the API to any particular form, function, or appearance.

As described above, in some embodiments, interrupt code restrictions may be enforced, e.g., to accommodate the particular requirements and constraints of different execution target platforms. For example, interrupt code restrictions may allow or disallow memory allocation by the ISR. The allowable operations for an ISR may be a subset of the allowable operations for a subroutine reentrant VI. For example, in some embodiments, the unallowable operations may include asynchronous operations (File I/O, TCP/IP, Bluetooth, IrDA, etc.), as well as those that cause memory allocation (Strings, Arrays, etc.)

In some embodiments, hardware specific or special function registers may be accessed and/or modified via special code to peek or poke registers. For example, a LabVIEW based VI ISR may access this functionality using an inline “C” node.

Example Use Cases

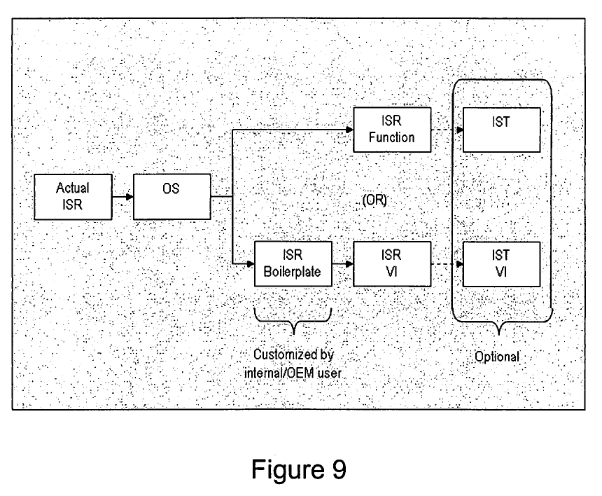

Two typical users to contend with when regarding ISR support include:
1). An external customer wishing to utilize the support provided for their hardware; and
2). An internal or original equipment manufacturer (OEM) customer wishing to provide support to new hardware.
   FIGS. 7 and 8—External Customer Use Cases

FIGS. 7 and 8 illustrate use cases for an external customer. FIG. 7 illustrates an example block diagram or graphical program that utilizes while loops and occurrences, according to one embodiment.

As FIG. 7 shows, this example block diagram or graphical program includes an ISR node, indicated by the dark icon with the exclamation mark, and labeled “interrupt.vi”. As may be seen, this node is wired to a registration node, indicated by an “asterisk/exclamation mark” icon which may execute to register the ISR at runtime. Note that on the far right of the diagram, a deregistration node is included for disabling the ISR. Note also that in this example, an interrupt may trigger the ISR node, which may trigger an occurrence, shown in the left portion of the diagram, and labeled “occurrence”. The occurrence functionality is shown inside the while loop in the right portion of the diagram, represented by a text-code fragment labeled “do IST work here”, referring to the functionality performed by the interrupt service thread. In other words, this portion of the diagram may include program code, in this particular case, C code (although the code could also be graphical), which may be invoked and executed on an interrupt service thread, as mentioned above.

FIG. 8 illustrates an example embodiment where an occurrence is used to trigger the interrupt service thread execution. More specifically, FIG. 8 displays the contents of “interrupt.vi” referenced in FIG. 7, according to one embodiment. Note that it is the ISR VI that is registered to a specific vector. As indicated, FIG. 8 illustrates an example embodiment where an interrupt is acknowledged and cleared, and in response, an occurrence is used to trigger the IST execution to complete the actual work of handling the interrupt.

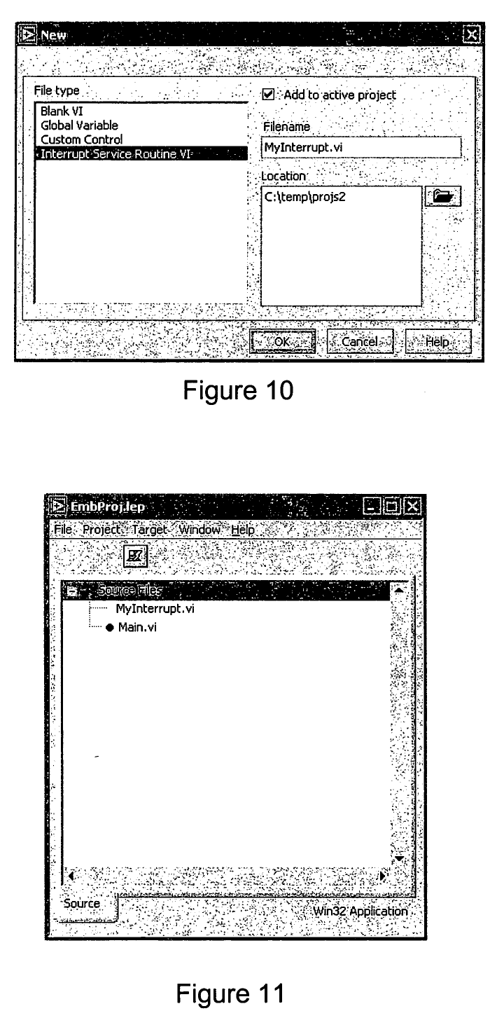

FIG. 9—Traditional vs. VI Path for ISR/IST

FIG. 9 illustrates high-level path differences between traditional handling of interrupts and an approach using graphical programs (e.g., VIs), according to one embodiment. As FIG. 9 shows, each path begins with an actual ISR that initiates the sequence of actions in both approaches via the OS, which with the ISRs are presumably registered. In the traditional (prior art) approach, represented by the top path, an ISR function is invoked, which may perform some specified functionality, and which in turn may optionally invoke an interrupt service thread (IST).

The bottom path represents one embodiment corresponding to the method described above with reference to FIG. 5. As may be seen, in this approach an ISR “boilerplate” function may be invoked by the OS. This function may be provided for users as a basic starting point for their own “custom” ISR VIs. In other words, basic functionality may be provided by the boilerplate function, which may in turn invoke the ISR VI, as shown. Note that the boilerplate function may be supplied by an OEM, e.g., specifically for a particular hardware device, and that this function may provide at least minimum necessary functionality to put an ISR into an appropriate state or condition to call an ISR, e.g., into a state ready to call a fixed connector pane VI. As FIG. 9 shows, the ISR boilerplate function may invoke an ISR VI, also referred to as an ISR, which may optionally invoke an IST VI to perform a function on an IST.

In one embodiment, if an OEM customer wishes to support ISR functionality on their hardware and OS platform, they may implement a set of functions available for use by or in the development environment. For example, in one implementation embodiment, the functions may be stored in a file such as OEM_LVISR.c, or equivalent, which may reside in a platform specific area of a C-Generator runtime library. The function prototypes may be defined in a corresponding header file, e.g., LVISR.h.

Following this example implementation, the following functions may be provided:

Boolean InitOEMISRs( );

This routine is preferably not called directly, e.g., is preferably only called by InitISRs, and may be provided by the target vendor. It may perform any ISR subsystem initialization necessary; and returns TRUE on success, FALSE on failure.

Boolean UninitOEMISRs( );

This routine is preferably not called directly, e.g., is preferably only called by UninitISRs, and may be provided by the target vendor. It may perform any ISR subsystem cleanup necessary; and returns TRUE on success; FALSE on failure.

Boolean OEMISRRegisterHandler(uInt32 isr_vector,

uInt32 isr_param,
ISRFunc isr_runFunc,
uInt32*register_param);

This routine is preferably not called directly, e.g., is preferably only called by ISRRegisterHandler, and may be provided by the target vendor. This routine may perform the actual registration of the interrupt with the OS or with the hardware (in the case of bare-metal).

In this example, isr_vector is the intended vector, isr_param is the parameter. Both isr_vector and isr_param may be passed to the ISRFunc isr_runFunc. register_param is a parameter that may be used by the OEM routine to return a parameter specific to this ISR registration instance. Upon unregstration of the ISR, the value stored in register_param may be passed in to the unregister call. This function returns TRUE on success, FALSE on failure.

Boolean OEMISRUnregisterHandler(uInt32 isr_vector,

uInt32 isr_param,
ISRFunc isr_runFunc,
uInt32 register_param);

This routine is preferably not called directly, e.g., is preferably only called by ISRUnregisterHandler, and may be provided by the target vendor. It may unregister an ISR at a given vector. The register_param passed in is the register parameter returned by the OEMISRRegisterHandler routine described above. This function returns TRUE on success, FALSE on failure.

Note that these functions are presented for example purposes only, and are not intended to limit the techniques and implementations to any particular set of functions, functionality, organization, or appearance.

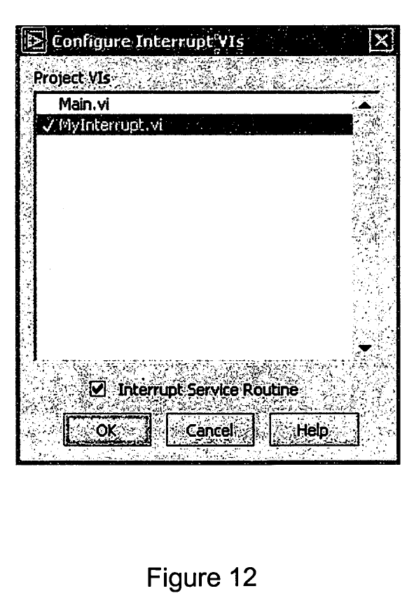

FIGS. 10-12—User Interface

In preferred embodiments, a user interface, e.g., a graphical user interface (GUI) may be provided for invoking and managing the functionality described herein. The following describes one embodiment of such a GUI directed to an embedded application, although it should be noted that the GUI shown is meant to be exemplary only, and is not intended to limit the interface to any particular form, function, or appearance. More specifically, FIGS. 10-12 step through an example user experience of setting up an interrupt service via a series of dialogs.

As FIG. 10 shows, in this example, the user may create an embedded project, e.g., within an IDE, such as LabVIEW, and may implement an interrupt service routine via a “New . . . ” menu item to add an interrupt service routine VI (ISR VI). In the embodiment shown, the ISR VI may be similar to a standard VI, but with a specific connector pane already set up. In other words, as mentioned above, the ISR VIs communication interface may be pre-defined, and may be constant or immutable. Thus, as shown in FIG. 10, the user has invoked creation of an ISR VI with the name “MyInterrupt.vi”, and added the VI to the active project, where the new VI is located in C:\temp\projs2.

After creating the ISR VI, the VI may be displayed in the embedded project file list, as indicated in FIG. 11.

Thus, the ISR VI may be displayed in the project file list as any other VI in the project. In one embodiment, the user may then select which VIs are configured as interrupt service routines, as shown in FIG. 12. For example, the dialog of FIG. 12 may be displayed when the user selects an Embedded Project menu item “Target->Configure Interrupt VIs”, or equivalent.

At this point, the user may enable and disable interrupts via a static reference to the ISR VI. For an example of this, refer to the registration VI portion of the use case described above with reference to FIG. 7. Note that the user may need to know what interrupt vector they need to register, which may depend on the target hardware and OS.

Note that an ISR VI may be configured to be an ISR in various ways. For example, in one embodiment, the ISR mode may be an execution priority. In another embodiment, an ISR VI may be a separate VI type specifically for interrupt service routines, e.g., denoted by an .vii file extension.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-implemented method for handling interrupts in a graphical program, the method comprising:
storing a graphical program on a host computer, wherein the graphical program comprises a plurality of interconnected nodes which visually indicate functionality of the program, and wherein the graphical program is executable to access a device;
storing an interrupt service routine (ISR); and
executing the graphical program, wherein said executing comprises:
registering the ISR with the host computer; and
executing the ISR in response to an interrupt from the device.

2. The method of claim 1, further comprising:
creating the graphical program in response to user input; and
creating the ISR in response to user input.

3. The method of claim 2, wherein said creating the graphical program and said creating the ISR are performed on another computer system, the method further comprising:
deploying the graphical program and the ISR to the host computer.

4. The method of claim 2, wherein the graphical program comprises program instructions that are executable to perform said registering the ISR.

5. The method of claim 4, wherein said creating the graphical program comprises:
including the program instructions in the graphical program that are executable to perform said registering the ISR in response to user input.

6. The method of claim 5, wherein said including program instructions in the graphical program comprises:
including an ISR registration node in the graphical program in response to user input.

7. The method of claim 5, wherein said including program instructions in the graphical program comprises:
displaying a configuration graphical user interface (GUI) in response to user input;
receiving user input to the configuration GUI specifying registration of the ISR; and
generating the program instructions in the graphical program in response to said specifying.

8. The method of claim 2, wherein said creating the graphical program comprises:
including an ISR node in the graphical program in response to user input, wherein the ISR node represents the interrupt service routine (ISR).

9. The method of claim 8, wherein ISR node comprises text-based program code.

10. The method of claim 8, wherein ISR node comprises graphical program code.

11. The method of claim 2, wherein said creating the graphical program comprises:
displaying a configuration graphical user interface (GUI) in response to user input;
receiving user input to the configuration GUI specifying the ISR; and
programmatically generating the program instructions implementing the ISR in response to said specifying.

12. The method of claim 2, wherein said creating the graphical program comprises:
arranging a plurality of nodes on a display; and
interconnecting the plurality of nodes in response to user input.

13. The method of claim 1, wherein said registering the ISR comprises:
loading a function pointer for the ISR into a register of the host computer.

14. The method of claim 1, wherein executing the ISR in response to an interrupt from the device comprises executing the ISR to perform:
acknowledging the interrupt;
clearing the interrupt; and
invoking a function.

15. The method of claim 14, wherein said invoking a function comprises:
invoking an interrupt service thread.

16. The method of claim 1,
wherein the graphical program comprises a block diagram portion and a user interface portion.

16. The method of claim 16,
wherein the block diagram portion executes on a first computer system, and the user interface portion executes on a second computer system coupled to the first computer system over a network.

18. The method of claim 1,
wherein the graphical program comprises a graphical data flow program.

19. The method of claim 1,
wherein the graphical program is operable to perform one or more of:
an industrial automation function;
a process control function; and
a test and measurement function.

20. The method of claim 19,
wherein, during execution of the graphical program, the graphical user interface is displayed on a display of a first computer system and the block diagram executes on a second computer system.

21. A memory medium comprising program instructions, wherein the program instructions are executable by a processor to perform:
storing a graphical program, wherein the graphical program comprises a plurality of interconnected nodes which visually indicate functionality of the program, and wherein the graphical program is executable to access a device;
storing an interrupt service routine (ISR);
executing the graphical program, wherein said executing comprises:
registering the ISR with the device; and
the ISR executing in response to an interrupt from the device.

22. A system for handling interrupts in a graphical program, the system comprising:
a host computer comprising:
a processor; and
a memory medium coupled to the processor; and
a device coupled to the host computer;
wherein the memory medium stores:
a graphical program, wherein the graphical program comprises a plurality of interconnected nodes which visually indicate functionality of the program, and wherein the graphical program is executable to access the device; and
an interrupt service routine (ISR);
wherein the graphical program is executable to register the ISR with the host computer;
wherein the device is operable to generate an interrupt; and
wherein the ISR is operable to execute in response to the interrupt from the device.

23. A computer-implemented method for handling interrupts in a graphical program, the method comprising:
storing an interrupt service routine (ISR);
storing a graphical program on a host computer, wherein the graphical program comprises a plurality of interconnected nodes which visually indicate functionality of the program, wherein the graphical program comprises a first node representing the ISR, and wherein the graphical program is executable to access a device; and
executing the graphical program, wherein said executing the graphical program comprises:
registering the ISR with the host computer; and
executing the first node in response to an interrupt from the device, wherein said executing the first node comprises executing the ISR.
